(19) United States
(12) Patent Application Publication
(10) Pub. No.: US 2025/0340307 A1
(43) Pub. Date: Nov. 6, 2025

(54) Systems And Methods For Improved Drone Network Resilience Against Electronic Warfare

(71) Applicant: Skydio, Inc., San Mateo, CA (US)

(72) Inventors: Adam Parker Bry, Redwood City, CA (US); Abraham Galton Bachrach, Emerald Hills, CA (US); Eyal Hochdorf, Palo Alto, CA (US)

(21) Appl. No.: 19/197,300

(22) Filed: May 2, 2025

Related U.S. Application Data
(60) Provisional application No. 63/642,392, filed on May 3, 2024.

(51) Int. Cl. B64D 45/00; G01S 1/04; G06F 1/3209; G06F 1/3287

(52) U.S. Cl. CPC B64D 45/00; G01S 1/0423; G06F 1/3209; G06F 1/3287

(57) ABSTRACT

Drone resilience against electronic warfare (EW) is enhanced by repurposing “downed” drones as navigational beacons or communication nodes within a mesh network. The techniques leverage remaining capabilities of the downed drones to support the operational continuity of active drones, creating a self-sustaining and robust aerial network. The downed drones are repurposed into passive navigational beacons or communication nodes to assist active drones—those still flying on a same or overlapping mission—in overcoming EW threats. The navigational beacons may include radio frequency (RF) signals or visual signals (e.g., infra-red (IR) or light emitting diode (LED) lights) encoded with location or position data of the downed drone. Active drones may use this position data to estimate their own positions and navigate accordingly to continue their missions.

### CROSS-REFERENCE TO RELATED APPLICATION(S)

This application claims the benefit of U.S. Provisional Patent Application No. 63/642,392, filed May 3, 2024, the entire disclosure of which is hereby incorporated by reference.

### TECHNICAL FIELD

This disclosure relates to unmanned aerial vehicles (UAVs), and more specifically, to UAV resiliency against electronic warfare.

### BACKGROUND

In modern warfare, drones play a crucial role in intelligence, reconnaissance, and surveillance (ISR) combat operations. However, their effectiveness is often compromised by electronic warfare (EW) tactics such as global positioning system (GPS) jamming and communication interference, which can disable or mislead drones. Current systems have limited resilience against such EW attacks, leading to significant operational failures.

### SUMMARY

In some aspects, the techniques described herein relate to a system configured to enhance resilience against electronic warfare, including: a plurality of drones each configured to switch to a low power mode upon being downed; a processing system configured to: continually determine whether a drone of the plurality of drones has been downed, and emit a beacon signal from a downed drone, the beacon signal containing position data; and a communication system enabling formation of a mesh network among downed and active drones of the plurality of drones.

In some aspects, the techniques described herein relate to a method for controlling an unmanned aerial vehicle (UAV) to enhance resilience against electron warfare, the method including: continually monitoring, by the UAV, one or more sensors or sub-systems of the UAV to determine that the UAV has been downed; and responsive to detecting that the UAV has been downed, entering a downed state, wherein in the downed state, the UAV: determines an estimated location of the UAV, deactivates non-essential systems and functions, and periodically broadcasts any of radio-frequency (RF) signal or visual signal that include the estimated location of the UAV.

In some aspects, the techniques described herein relate to an autonomous unmanned aerial vehicle (UAV) including: a propulsion system; one or more sensors configured to capture perception inputs of a physical environment; a propulsion system configured to maneuver the UAV through the physical environment; a communication system configured to receive navigation beacon signals transmitted by a set of downed UAVs in a plurality of UAVs, wherein the navigation beacon signals is encoded with estimated locations of the set of downed UAVs; and a processing system configured to: determine that the UAV is experiencing any of lost or degraded global positioning system (GPS) or communication signaling, process the navigation beacon signals transmitted by the set of downed UAVs to generate navigation instructions, and process the navigation instructions to direct the propulsion system to navigate the UAV.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example configuration of a top side of an unmanned aerial vehicle (UAV), consistent with various embodiments.

FIG. 2 illustrates an example configuration of a bottom side of the UAV, consistent with various embodiments.

FIG. 3 illustrates an example UAV architecture for a UAV configured with improved resilience against electronic warfare (EW), consistent with various embodiments.

FIG. 4 illustrates an example environment for implementing UAV resilience against EW, consistent with various embodiments.

FIG. 5 is a flow diagram of a method for enhancing UAV resiliency against EW, consistent with various embodiments.

FIG. 6 is a flow diagram of a method for controlling an active drone using navigation beacons from a downed drone, consistent with various embodiments.

FIG. 7 illustrates a state diagram representing the operational states and transitions of a drone (or UAV) configured to enhance survivability under EW conditions, consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

Disclosed are embodiments for enhancing drone resilience against electronic warfare (EW) by repurposing “downed” drones as navigational beacons or communication nodes within a mesh network. The techniques described herein leverage the remaining capabilities of downed drones to support the operational continuity of active drones, thereby forming a self-sustaining and robust aerial network.

As noted above, EW and drones dominate modern battlefield, often in direct competition. Global positioning system (GPS) signals are almost always jammed, and communication signals, such as radio control (RC), telemetry or first-person view (FPV) video feed, are frequently disrupted. When both GPS and communication signals are jammed, drones often go down (i.e., become “downed”). A downed drone is one that has been rendered inoperative or forced to land, either intentionally or unintentionally, and is no longer flying or functioning as intended. In some embodiments, causes for a downed drone can include system failure, environmental interference, manual override, or deliberate countermeasures, resulting in an uncontrolled descent, crash, or emergency landing.

In some embodiments, downed drones are repurposed as passive navigational beacons or communication nodes to assist active drones-non-downed drones that are still flying on a same or overlapping mission-in overcoming EW. The navigational beacons may be radio frequency (RF) signals or visual signals (e.g., infra-red (IR) or light emitting diode (LED) light) encoded with location or position data of the downed drone. Active drones may use this position data to estimate their own position, navigate accordingly, and continue with their mission.

In some embodiments, downed drones function as communication nodes in a mesh network, enhancing group or fleet resilience. For example, in a multi-drone mission, an adversary may be able to bring down a first wave of drones, but those downed drones, now acting as navigational beacons or nodes, increase the survivability of following drones, creating an advancing, resilient front. This creates a resilient, self-sustaining mesh network that improves both survivability and navigational capabilities of active drones.

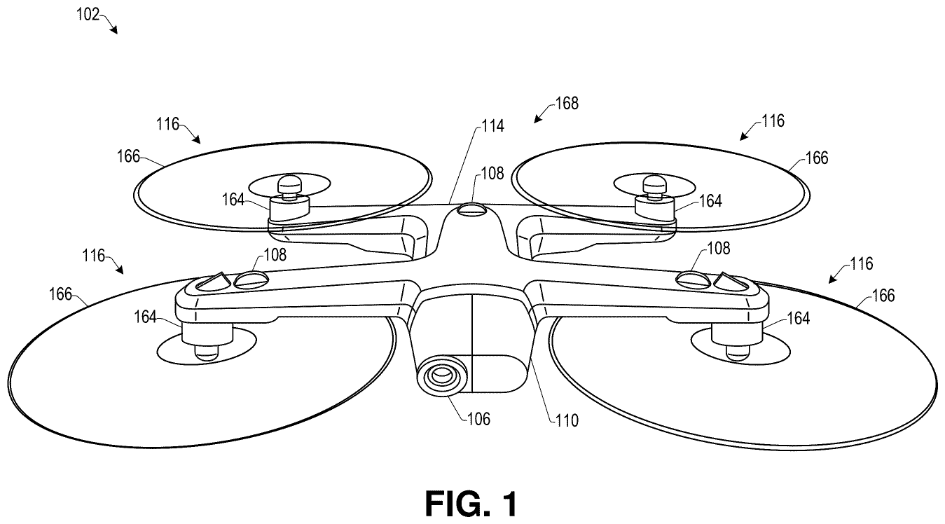

FIG. 1 illustrates an example configuration of a top side of an UAV, consistent with various embodiments. In this example, the UAV 102 includes a propulsion system 116 including four motors 164 and propellers 166 that is configured to maneuver the UAV through a physical environment. In this example, the UAV 102 is illustrated as a quadcopter drone, but implementations herein are not limited to such.

The UAV 102 includes a plurality of the second cameras 108 mounted on the body 114 of the UAV 102 and that may be used as navigation cameras in some cases. The UAV 102 further includes the aimable first camera 106 that may include a higher-resolution image sensor than the image sensors of the wider-angle cameras 108. In some cases, the first camera 106 includes a fixed focal length lens. In other cases, the first camera 106 may include a mechanically controllable, optically zoomable lens. The first camera 106 is mounted on the gimbal 110 that enables aiming of the first camera 106 in approximately a 180-degree hemispherical area to support steady, low-blur image capture and object tracking. For example, the first camera 106 may be used for capturing high resolution images of target objects, providing object tracking video, or various other operations.

In this example, three second cameras 108 are spaced out around the top side 168 of the UAV 102 and covered by respective fisheye lenses to provide a wide field of view and to support stereoscopic computer vision. The wider-angle cameras 108 on the top side 168 of the UAV 102, as well as those on the bottom side discussed below, may be precisely calibrated with respect to each other following installation on the body 114 of the UAV 102. As a result of the calibration, for each pixel in each of the images captured by the respective wider-angle cameras, the precise corresponding three-dimensional (3D) orientation with respect to a virtual sphere surrounding the UAV may be determined in advance. In some cases, six wider-angle cameras 108 are employed with a field of view (FOV) sufficiently wide (e.g., 180-degree FOV, 200-degree FOV, etc.) and are positioned on the body 114 of the UAV 102 for covering the entire spherical space around the UAV 102.

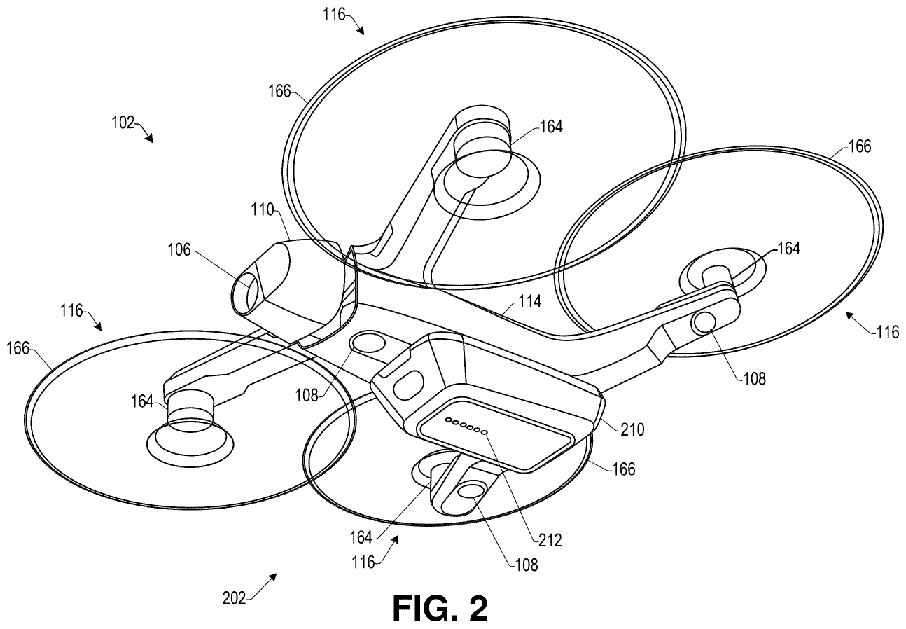

FIG. 2 illustrates an example configuration of a bottom side of the UAV, consistent with various embodiments. From this perspective three more second cameras 108 arranged on the bottom side 202 of the UAV 102 are illustrated. The second cameras 108 on the bottom side 202 may also be covered by respective fisheye lenses to provide a wide field of view and to support stereoscopic computer vision. This array of second cameras 108 (e.g., three on the top side and three on the bottom side of the UAV 102) may enable visual inertial odometry (VIO) for high resolution localization and obstacle detection and avoidance. For example, the array of second cameras 108 may be used to scan a surrounding area to obtain range data and provide image information that can be used to generate range maps indicating distances to objects detected in the FOVs of the second cameras 108, such as for use during autonomous navigation of the UAV 102 or for determining the distance of surfaces from the UAV 102.

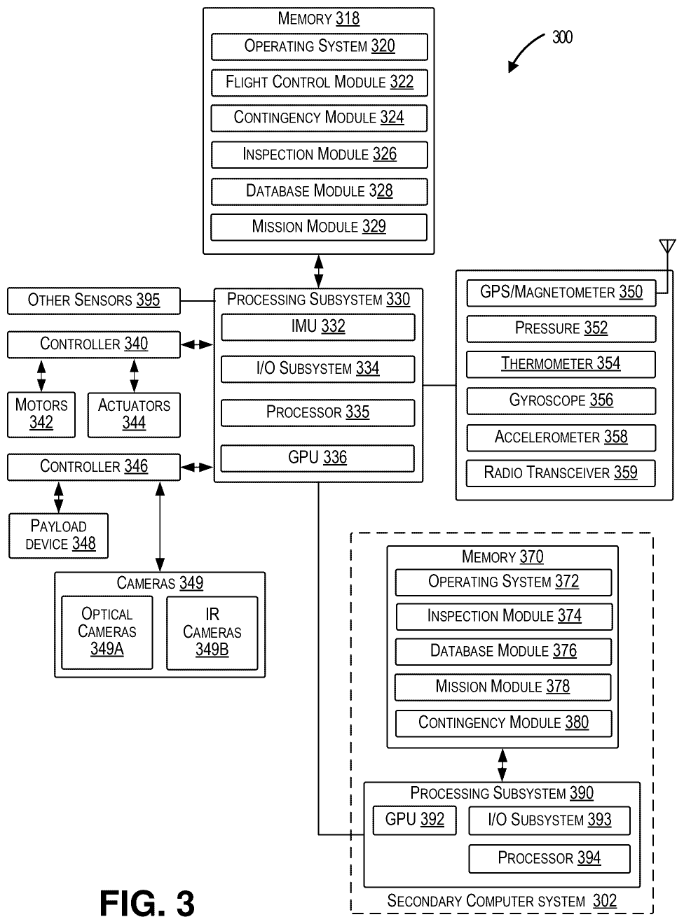

The UAV 102 may also include a battery pack 210 attached on the bottom side 202 of the UAV 102, with conducting contacts 212 to enable battery charging. The UAV 102 also includes an internal processing apparatus including one or more processors and a computer-readable medium (not shown in FIG. 2) as well as various other electronic and mechanical components. For example, the UAV 102 may include a hardware configuration as discussed with respect to FIG. 3 below.

FIG. 3 illustrates an example UAV architecture for a UAV configured with improved resilience against EW, consistent with various embodiments. In the examples herein, the UAV 102 may sometimes be referred to as a “drone” and may be implemented as any type of UAV capable of controlled flight without a human pilot onboard. For instance, the UAV 102 may be controlled autonomously by one or more onboard processors, such as processor 335, that execute one or more executable programs. Additionally, or alternatively, the UAV 102 may be controlled via a remote controller, such as through a remotely located controller operated by a human pilot and/or controlled by an executable program executing on or in cooperation with the controller.

A UAV can include a primary computer system 300 and a secondary computer system 302. The UAV primary computer system 300 can be a system of one or more computers, or software executing on a system of one or more computers, which is in communication with, or maintains, one or more databases. The UAV primary computer system 300 can include a processing subsystem 330 including one or more processors 335, graphics processing units 336, I/O subsystem 334, and an inertial measurement unit (IMU) 332. In addition, the UAV primary computer system 300 can include logic circuits, analog circuits, associated volatile and/or non-volatile memory, associated input/output data ports, power ports, etc., and include one or more software processes executing on one or more processors or computers. The UAV primary computer system 300 can include memory 318.

Memory 318 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The UAV primary computer system 300 may be coupled to one or more sensors, such as global navigation satellite system (GNSS) receivers 350 (e.g., GPS receivers), thermometer 354, gyroscopes 356, accelerometers 358, pressure sensors (static or differential) 352, and other sensors 395 that capture perception inputs of a physical environment. The other sensors 395 can include current sensors, voltage sensors, magnetometers, hydrometers, anemometers and motor sensors. The UAV may use IMU 332 in inertial navigation of the UAV. Sensors can be coupled to the UAV primary computer system 300, or to controller boards coupled to the UAV primary computer system 300. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 300 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 322 handles flight control operations of the UAV. The module interacts with one or more controllers 340 that control operation of motors 342 and/or actuators 344. For example, the motors may be used for rotation of propellers, and the actuators may be used for flight surface control such as ailerons, rudders, flaps, landing gear and parachute deployment.

The contingency module 324 monitors and handles contingency events. For example, the contingency module 324 may detect that the UAV has crossed a boundary of a geofence, and then instruct the flight control module 322 to return to a predetermined landing location. The contingency module 324 may detect that the UAV has flown or is flying out of a visual line of sight (VLOS) from a ground operator, and instruct the flight control module 322 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 329 processes the flight plan, waypoints, and other associated information with the flight plan as provided to the UAV in a flight package. The mission module 329 works in conjunction with the flight control module 322. For example, the mission module may send information concerning the flight plan to the flight control module 322, for example waypoints (e.g., latitude, longitude and altitude), flight velocity, so that the flight control module 322 can autopilot the UAV.

The UAV may have various devices connected to the UAV for performing a variety of tasks, such as data collection. For example, the UAV may carry one or more cameras 349. Cameras 349 can include one or more visible light cameras 349A, which can be, for example, a still image camera, a video camera, or a multispectral camera. The UAV may carry one or more infrared cameras 349B. Each infrared camera 349B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 318 of the UAV primary computer system 300.

The UAV primary computer system 300 may be coupled to various radios, e.g., transceivers 359 for manual control of the UAV, and for wireless or wired data transmission to and from the UAV primary computer system 300, and optionally a UAV secondary computer system 302. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 320 and storing the information in computer-readable media (e.g., non-volatile memory 318). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 320. In some implementations, the operating system 320 can be a real time operating system (RTOS), UNIX, LINUX, OS X, WINDOWS, ANDROID or other operating system 320. Additionally, other software modules and applications may run on the operating system 320, such as a flight control module 322, contingency module 324, inspection module 326, database module 328 and mission module 329. In particular, inspection module 326 can include computer instructions that, when executed by processor 335, can cause processor 335 to control the UAV to perform solar panel inspection operations as described below. Typically, flight critical functions will be performed using the UAV primary computer system 300. Operating system 320 may include instructions for handling basic system services and for performing hardware dependent tasks.

In addition to the UAV primary computer system 300, the secondary computer system 302 may be used to run another operating system 372 to perform other functions. The UAV secondary computer system 302 can be a system of one or more computers, or software executing on a system of one or more computers, which is in communication with, or maintains, one or more databases. The UAV secondary computer system 302 can include a processing subsystem 390 of one or more processors 394, GPU 392, and I/O subsystem 393. The UAV secondary computer system 302 can include logic circuits, analog circuits, associated volatile and/or non-volatile memory, associated input/output data ports, power ports, etc., and include one or more software processes executing on one or more processors or computers. The UAV secondary computer system 302 can include memory 370. Memory 370 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 302 will be non-critical functions in nature. If the function fails, the UAV will still be able to operate safely. The UAV secondary computer system 302 can include operating system 372. In some implementations, the operating system 372 can be based on real time operating system (RTOS), UNIX, LINUX, OS X, WINDOWS, ANDROID or other operating system.

Additionally, other software modules and applications may run on the operating system 372, such as an inspection module 374, database module 376, mission module 378 and contingency module 380. In particular, inspection module 374 can include computer instructions that, when executed by processor 394, can cause processor 394 to control the UAV to perform solar panel inspection operations as described below. Operating system 372 may include instructions for handling basic system services and for performing hardware dependent tasks.

The UAV can include controllers 346. Controllers 346 may be used to interact with and operate a payload device 348, and other devices such as cameras 349A and 349B. Cameras 349A and 349B can include a still-image camera, video camera, infrared camera, multispectral camera, stereo camera pair. In addition, controllers 346 may interact with a Lidar, radio transceiver, sonar, laser ranger, altimeter, TCAS, ADS-B (Automatic dependent surveillance-broadcast) transponder. Optionally, the secondary computer system 302 may have controllers to control payload devices.

The UAV 102 illustrated in FIGS. 1-3 is an example provided for illustrative purposes. The UAV 102 in accordance with the present disclosure may include more or fewer components than are shown. For example, while a quadcopter is illustrated, the UAV 102 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 102 may be guided by other types of vehicles (e.g., spacecraft, land vehicles, watercraft, submarine vehicles, etc.).

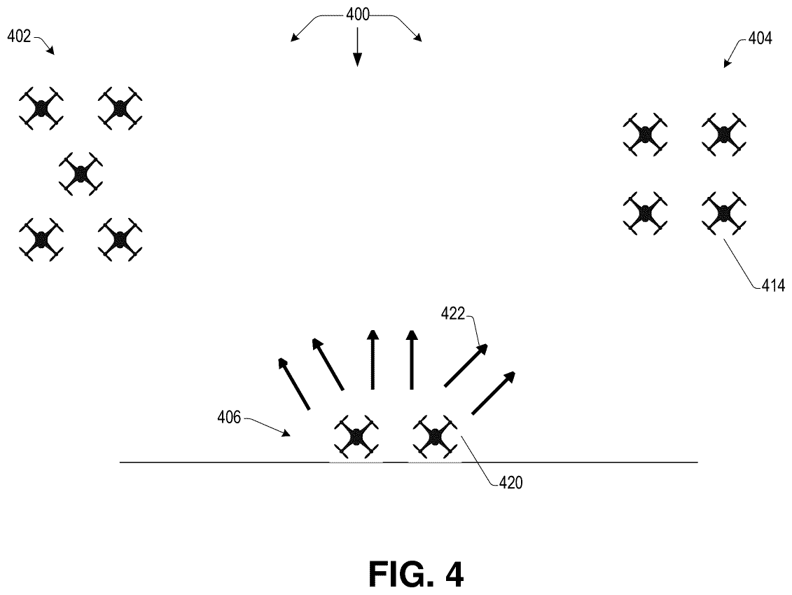

FIG. 4 illustrates an example environment for implementing UAV resilience against EW, consistent with various embodiments. A fleet of drones 400, such as UAVs 102, may be launched on a mission. The drones may be launched at the same time, or different drones may be launched at different times. One or more drones may become downed due to various reasons. For example, a drone may become downed due to (a) signal loss (e.g., GPS or RC signal jamming, common in EW), (b) battery depletion, (c) mechanical or electronic failure, (d) environmental factors (strong wind, bird strike, electromagnetic interference), (e) anti-drone measures (jamming, spoofing, net guns, directed energy), (f) collision or mid-air entanglement, or (g) pilot error. Typically, a downed drone is one that has been rendered inoperative or forced to land, either intentionally or unintentionally, and is no longer flying or functioning as intended. In the example of FIG. 4, drones 406 are downed (also referred to as a set of downed drones 406), while drones 402 and 404 remain operational (e.g., non-downed or active drones). The drones 402 may be referred to as the first set of active drones 402 and drones 404 as the second set of active drones 404.

When a drone is downed, such as the drowned drone 420, the downed drone 420 is configured to perform “downed operations” including, but not limited to, switching to a low-power mode and emitting navigation beacons that active drones can use for navigation. In low-power mode, the downed drone is configured to shut off, deactivate, reduce frequency, or perform on-demand activation of non-essential services (e.g., functions and sub-systems/components). For example, the set of downed drones 406 may shut down cameras, controllers, and unused sensors. The remaining services (still functioning sub-systems or functions) may switch to or remain in low-power mode, periodically waking (e.g., every 30 seconds), to transmit signals.

In some implementations, the UAV includes a power management module configured to classify onboard components as “critical” or “non-critical” using a dependency graph stored in memory. The power management module can dynamically adjust duty cycles, clock frequencies, or disable power domains based on remaining battery life thresholds. Non-critical systems such as secondary image processors or non-transmitting cameras may be assigned “sleep schedules” in which they are deactivated or queried only upon demand from the communications system or when beacon broadcast timing is reached. For example, at a remaining battery life of 30%, the system may reduce processing frequency on non-critical microcontrollers. At 20%, it may shut down secondary processors. At 10%, it may activate ultra-low-power “zombie” mode using only beacon broadcast subsystems.

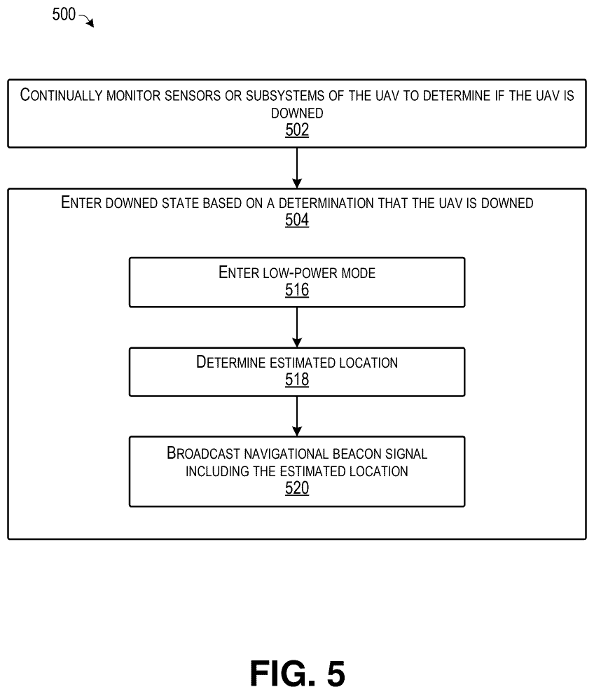

The downed drone 420 is also configured to emit periodic navigation beacons 422, including RF or visual signals (e.g., IR or visible LEDs) that active drones can use for navigation. In some embodiments, the RF signals are encoded with the downed drone's estimated location. The downed drone 420 may estimate its location using several ways, such as GPS, barometer, IMU, or other onboard sensors, which is described in detail at least with reference to FIG. 5 below. Active drones within range receive the broadcast navigation beacon signals and use the estimated location data to estimate their own position so that they can navigate autonomously even in the absence of GPS. For example, active drone 414 that is experiencing a loss of, or degraded, navigational signal reception (e.g., GPS signal) or communicational signal reception (e.g., RC signals from ground control station), may use the estimated location or position data from the downed drone 420 from the navigation beacons 422 to estimate its own location and use it to navigate and continue with the mission.

In some implementations, the RF beacons are modulated using binary phase-shift keying (BPSK) or chirp spread spectrum to increase resilience against narrowband interference. The beacon payload can include one or more of timestamp of last known good position fix, estimated current position in WGS84 format, a confidence score (e.g., float [0.0, 1.0]), and ID and health state. In some variants, the RF beacons use ultra-wideband (UWB) for short-range, high-resolution time-of-flight (ToF) ranging. In some implementations, visual beacons may be modulated via IR LED pulses in a coded temporal sequence (e.g., Morse-like encoding), which can be decoded by computer vision algorithms on nearby drones.

The fleet of drones 400 may also be configured to form a mesh network of communication nodes, enhancing communication resilience and operational integrity across the drone fleet. In a mesh network, each node (drone) connects directly to one or more other nodes, enabling data to relay across multiple paths. This decentralized design increases redundancy and reliability-if one node fails, data can still reach its destination through alternate routes. The mesh network may be any of various topologies. For example, the mesh network may be a full mesh network, where every drone connects with every other drone in the fleet. In another example, the mesh network may be a partial mesh network where connections are established selectively based on communication needs. The mesh network allows data (e.g., position data) to hop from drone to drone until it reaches the target drone, thereby enhancing communication resilience. For example, if the active drone 414 is out of communication range of downed drone 420, the position data of the downed drone 420 may still reach the active drone 414 via relays through one or more drones in the set of drones 404.

Thus, by leveraging downed drones to aid navigation of the active drones, and optionally establishing a mesh network among the fleet of drones, the system enhances resilience and self-sustainability, improving the operational drones' survivability, navigation performance, and robustness against EW threats.

In some implementations, the mesh communication protocol may use a lightweight distributed routing protocol such as Ad hoc On-Demand Distance Vector (AODV) or Optimized Link State Routing (OLSR). Nodes periodically broadcast HELLO packets containing their status (e.g., active/downed), estimated position, role (beacon/router/leaf), and battery state. If a node loses connectivity to its GCS, it broadcasts a route request (RREQ), which propagates via neighboring drones until a route reply (RREP) is returned. In some instances, the downed drones acting as mesh nodes can advertise reduced bandwidth capabilities and only respond to limited discovery probes to preserve power. The routing protocol supports link-layer retries and beacon rebroadcasting in sparse network regions.

FIG. 5 is a flow diagram of a method for enhancing UAV resiliency against EW, consistent with various embodiments. In some embodiments, the method 500 may be implemented in the environment of FIG. 4 and by UAV 102.

At block 502, the UAV continually monitors the sensors or subsystems to determine if the UAV has become downed. In some embodiments, each UAV in the fleet of drones of 400 performs this monitoring individually. Typically, a downed drone is one that has been rendered inoperative or forced to land, either intentionally or unintentionally, and is no longer flying or functioning as intended. As previously noted, the UAV may be downed due to various reasons, such as (a) signal loss (e.g., GPS or RC signal jamming, common in EW), (b) battery depletion, (c) mechanical or electronic failure, (d) environmental factors (strong wind, bird strike, electromagnetic interference), (e) anti-drone measures (jamming, spoofing, net guns, directed energy), (f) collision or mid-air entanglement, or (g) pilot error. In some embodiments, in EW contexts, signal loss or other anti-drone measures are frequent causes.

A determination of whether a drone is downed may be made by monitoring subsystems such as processing subsystem 330, or sensors, such as GPS sensor 350, radio transceiver 359, or other sensors 395. For example, by monitoring the GPS sensor 350 or radio transceiver 359, the processing subsystem 330 may detect a signal loss (e.g., GPS signal or other RC signals) and classify the UAV as downed. In another example, by monitoring the controller 340, the processing subsystem 330 may detect failure of the motors 342 or actuators 344. In such cases the UAV may be classified as downed. For example, the processing subsystem 330 of the drone 420 may determine that the drone 420 is downed.

At block 504, upon determining that the UAV is downed, the downed UAV is configured to transition into a downed-state. In the downed-state, the downed drone 420 is configured to perform specific operations, as described at least with reference to blocks 516-520 below.

At block 516, the downed drone 420 is configured to enter a low-power mode. In the low-power mode, the downed drone 420 is configured to shut off, deactivate, reduce frequency, or enable on-demand activation of non-essential services (e.g., specific functions and sub-systems/components) to conserver battery life. In some embodiments, non-essential services are functions or components other than those required for transmitting periodic navigation beacons. For example, the downed drone 420 may shut down cameras, controllers, and unused sensors. The remaining services (still functioning sub-systems or functions) may enter a low-power mode, e.g., periodically waking (e.g., every 30 seconds), to send signals. In some embodiments, services may be shut off or deactivated progressively as battery life decreases. For example, at a first battery threshold, the downed drone 420 may shut off a non-essential service such as the secondary computer system 302 while keeping other components such as the cameras, controllers and the sensors active. When the remaining battery life drops to a second lower threshold, the downed drone 420 may deactivate other non-essential services such as the controllers, then the cameras and the non-essential sensors and so on. In some embodiments, the frequency of execution of some of the non-essential services may also decrease progressively with the battery life.

At block 518, the downed drone 420 is configured to determine its estimated location. The processing subsystem 330 may determine the estimated location or its position data using a GNSS receiver, such as GPS. In some embodiments, the downed drone 420 may keep the GPS active so that if GPS is not jammed, the drone can get a fix on its position/location. GPS jamming is often less effective at ground level due to terrain or vegetation blocking the line-of-sight (LOS) to jammers (e.g., to at least ground based jammers). In some implementations, the downed drone 420 may also detect and reject GPS spoofing-i.e., false signals broadcast by adversaries to mislead the downed drone's position. The drones may detect and reject the GPS spoofing using any of known number of methods, such as via filtering.

In some embodiments, the downed drone 420 may also compute a confidence score, representing the probability that the estimated location is accurate.

The downed drone 420 may further refine, fine tune, or adjust the estimated location using several ways. For example, the downed drone 420 may refine the position data based on environmental data. In some embodiments, a downed drown may use a pressure sensor, such as a barometer, to estimate altitude (Z-height) based on the air pressure in the proximity of the downed drone. The downed drone 420 may also consider the barometer's reliability (i.e., was the barometer damaged in the crash/emergency landing) before refining the position data. The processing subsystem 330 may assess the accuracy of the barometer in several ways. For example, the processing subsystem 330 may validate the sensor readings (e.g., whether the pressure reading is within expected ranges), cross-reference sensor output with other sensor data (e.g., GPS or IMU data), or analyze fault-reports to identify if any faults or degradation of the barometer is reported. If the processing subsystem 330 deems the barometer reading to be unreliable, the processing subsystem may choose not to adjust the estimated location, or may adjust the estimated location while reducing the associated confidence score.

In some implementations, the downed drone 420 may include a position estimation module which implements a Kalman filter or particle filter to fuse sensor inputs from the GNSS receiver, barometer, IMU, and any received VIO data. When GPS lock is unavailable or suspected to be spoofed, the position estimation logic increases weight given to inertial deltas and barometric altimetry. The position estimate is updated using a prediction-correction loop, which may also incorporate known terrain features or landing pad coordinates if available. In some implementations, the system flags suspected spoofed GPS signals based on, for example, one or more of: sudden jumps exceeding a preset velocity threshold (e.g., >150 m/s), conflicts with IMU-derived acceleration or heading changes, or low correlation with recent confidence-weighted estimates.

In another example, the downed drone 420 may refine the position data based on movement data. In some implementations, the IMU 332 may detect if the drone has ever moved after determining the position; if so, the drone can reset its confidence score to zero—unless the downed drone 420 can recalculate the estimated location. The IMU 332 may use a combination of sensors, such as accelerometers, gyroscopes, and sometimes magnetometers, to track acceleration, angular velocity, and orientation, which give a sense of how and where the drone has moved over time. The IMU 332 may also support “dead reckoning”—estimating position based on a known starting point and subsequent movement.

The position data or the estimated location can be expressed as either an absolute or relative position of the downed drone 420. The absolute location refers to global coordinates (e.g., latitude, longitude, and altitude), determined using a sensor equipped to receive data from any GNSS, such as GPS, GLONASS, Galileo, BeiDou, etc. The relative location describes the drone's position in relation to a person, an object, or a takeoff point (e.g., launch location), typically using X (e.g., North/South), Y (e.g., East/West) and Z (e.g., height) axes. The relative location may be determined using one or more of IMU 332, pressure sensor 352 (e.g., barometer), visual odometry or LiDAR, real-time kinematic (RTK)-GPS or ultra-wideband (UWB) sensors.

At block 520, the downed drone 420 is configured to broadcast navigation beacons 422. The navigation beacons 422 contain the estimated location and its associated confidence score (e.g., from block 518). In some embodiments, the navigation beacons is an RF signal, or low-power technologies such as UWB can be employed to reduce energy usage. For example, in addition to shutting down unnecessary components, low power signaling, such as UWB, can be utilized for transmitting the navigation beacons 422.

In addition to the RF navigational beacon, the navigation beacons 422 may include a visual signal. For example, the downed drone may flash onboard IR light or visible LEDs in a coded pattern to convey positional information to nearby flying drones.

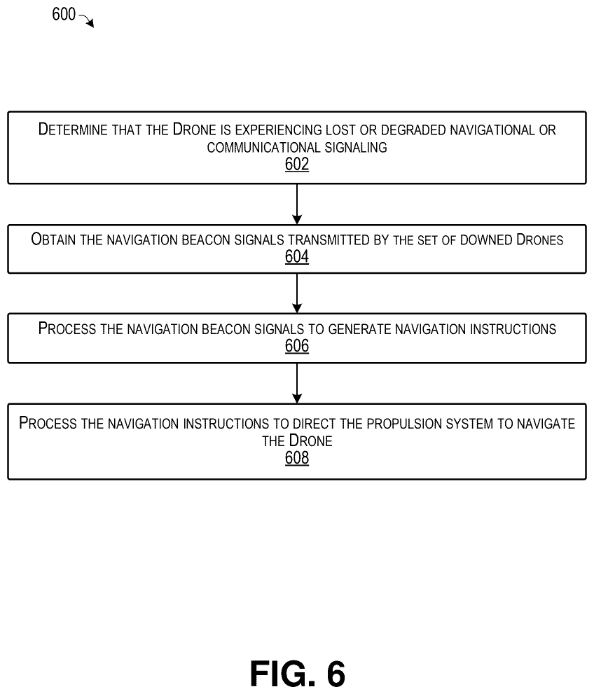

The active drones within range of the downed drones may receive the broadcast navigation beacons 422 and use the embedded estimated location for navigation, as described in detail at least with reference to FIG. 6 below.

FIG. 6 is a flow diagram of a method for controlling an active drone using navigation beacons from a downed drone, consistent with various embodiments. In some embodiments, the method 600 may be implemented in the environment of FIG. 4 and executed by the UAV 102.

At block 602, a processing subsystem 330 of the UAV determines whether an UAV, such as an active drone 414, is experiencing lost or degraded navigational or communication signals. For instance, the processing subsystem 330 may detect loss or degraded reception of navigational signals by monitoring one or more subsystems or sensors, such as GPS or magnetometer 350. In another example, the processing subsystem 330 may detect loss or degraded communication signal (e.g., signals from or to ground control station) reception by monitoring one or more subsystems or sensors, such as radio transceiver 359.

At block 604, upon detecting navigational or communication signal degradation or loss, the active drone 414 obtains the navigation beacons 422 from the set of downed drones 406. The active drone 414 may obtain the navigation beacons 422 from one or more drones of the set of downed drones 406. For example, the active drone 414 may obtain the navigation beacons 422 from the downed drone 420. Further, the active drone 414 may obtain the navigation beacons 422 from the downed drone 420 directly, or indirectly through other drones of the fleet 400 via a mesh network. For example, the navigation beacons 422 may be relayed to the active drone 414 through intermediary drones (e.g., via a first active drone and a second active drone of the set of active drones 404).

At block 606, the active drone 414 processes the navigation beacons 422 to generate navigation instructions. For example, the active drone 414 may extract the estimated location or position data of the downed drone 420 from RF signals or decode visual signals (e.g., IR or visible LEDs) captured by onboard cameras or other sensors of the active drone 414. In some embodiments, the processing subsystem 330 of the active drone 414 may also analyze signal characteristics such as angle of arrival (e.g., from which direction the signal comes), intensity (e.g., stronger=closer) and bearing (e.g., angle and direction) using computer vision algorithms to determine the estimated location of the downed drone 420. In some embodiments, the visual signals are particularly resilient in EW environments, as they are more difficult to jam than RF or GPS signals.

After obtaining the estimated position of the downed drone 420 using any of the above ways, the active drone 414 may then estimate its own position based on the derived estimated position of the downed drone 420. For example, the processing subsystem 330 of the active drone 414 may combine IMU data or data from other sensors (e.g., sensors 350-352) with the received estimated position of the downed drone 420 to determine the estimated position of the active drone 414. In another example, the active drone 414 can determine its range from the downed drone 420 and combine the range with the received estimated position of the downed drone 420 to determine the estimated position of the active drone 414. In some embodiments, the active drone 414 can determine its range using wireless positioning techniques such as Wi-Fi-standard round-trip time (RTT) or UWB-IR ranging protocols. While Wi-Fi RTT can provide meter level accuracy under LOS (e.g., approximately “3 m”), the UWB-IR offers an accuracy in the order of centimeters. In some embodiments, UWB can be used to measure RTT very precisely, making it ideal for ranging and indoor/outdoor positioning, especially when GPS is unavailable. Further, it has low interference with narrowband RF systems, and harder to jam or spoof than narrowband RF signals, making it useful in EW-resilient systems. In some embodiments, the range can also be estimated with orthogonal frequency division multiple access (OFDMA). In some embodiments, OFDMA makes RTT-based distance measurements more accurate, faster, and scalable across multiple drones. Different drones can simultaneously exchange ranging signals by each using different subcarriers and without colliding with each other. Using OFDMA reduces interference and improves the timing precision, both of which are critical for accurate RTT measurements.

In some implementations, a distributed positioning algorithm may be implemented across all drones in the fleet, downed and active, that are able to communicate with each other. They use their relative ranges, LED detections, and any known absolute positions within the group to update their own position estimates. Knowing the absolute location of at least a pair of drones may allow others to resolve their own positions (e.g., an absolute position) based on the relative ranges between them. Thus, the processing subsystem 330 generates the navigation instructions (e.g., flight path corrections) for the active drone 414 using the estimate location of the downed drone 420 from the navigation beacons 422.

At block 608, the processing subsystem 330 processes the navigation instructions to command the propulsion system 116 to navigate the active drone 414. The active drone 414 can then adjust its trajectory, continue the mission, or navigate to safety-all without relying on GPS. In this way, the navigation beacons 422 from the set of downed drones 406 assist the first set of active drones 402 and the second set of active drones 404 in navigating and maintaining mission integrity in GPS-denied, EW-contested environments.

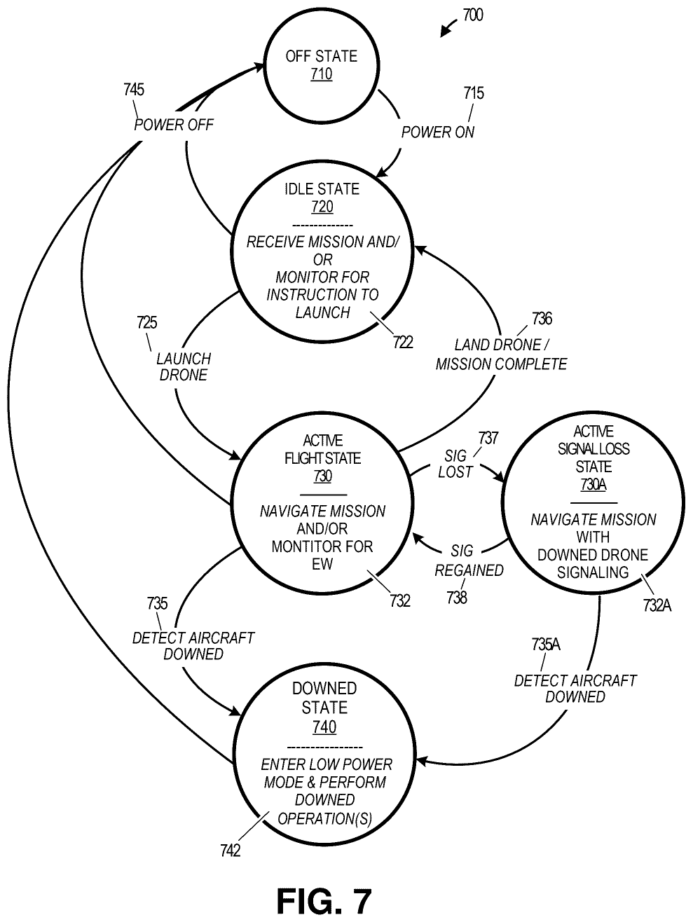

FIG. 7 illustrates a state diagram representing the operational states and transitions of a drone (or UAV) configured to enhance survivability under EW conditions, consistent with various embodiments. As shown in the example of FIG. 7, the state diagram 700 includes states 710, 720, 730, 730A and 740, entry actions 722, 732, 732A and 742, and transition conditions 715, 725, 735, 736, 737, 738, and 745. The example state operations and transitions shown in state diagram 700 may be performed in various embodiments by a drone (or UAV) such as, for example, the drone 102 of FIG. 1, or one or more processors, modules, engines, or components associated therewith. Additional or fewer states, entry actions and transition conditions are possible.

In an off state 710, a drone (e.g., one of the UAVs of fleet of drones 400) is powered off. That is, all the electronics of the drone are powered off.

Upon powering on 715, the drone transitions from the off state to an idle state 720. In the idle state 720, the drone is powered on and is ready to receive mission instructions (e.g., from ground control station) or continues to monitor for instructions to launch (722). From the idle state 720, the drone can transition to off state 710, or to active flight state 730 upon receiving launch instructions 725.

In the active flight state 730, the drone operates normally, following its flight plan using available GPS and communication signals. Actions (732) such as navigation, mission execution, monitoring for EW, and sensor data collection occur during this phase. From the active flight state 730, the drone can transition to active signal lost state 730A upon signal loss 737, to a downed state 740 upon detection of the drone being downed (735), or to the idle state 730 upon completion of mission or receiving instructions to land (736).

In the active signal lost state 730A, the drone detects loss of or degraded GPS or communication signals, and begins using alternative navigation aids, such as navigation beacons or visual signals from downed drones, to maintain course (732A), as described at least with reference to FIG. 6 above. The drone can revert to the active flight state 730 upon regaining GPS or communication signals (738), or transition to the downed state 740 upon detection of the drone being downed (735A).

In the downed state 740, the drone transitions to a low-power “downed” mode and performs downed operations (742), such as deactivating non-essential systems to conserve battery life, and periodically broadcasting navigation beacons or visual beacons containing its estimated location to support navigation of nearby active drones, as described in detail at least with reference to FIG. 5.

The drone can transition to the off state 710 from any of the states 720, 730 or 740 upon receiving power off (745) instructions.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

The present techniques will be better understood with reference to the following enumerated embodiments.

In some embodiments, a method for controlling an unmanned aerial vehicle (UAV) to enhance resilience against electron warfare is disclosed. The method comprises continually monitoring, by the UAV, one or more sensors or sub-systems of the UAV to determine that the UAV is experiencing lost or degraded GPS and/or communications; receiving navigation signaling transmitted by one or more downed drones, wherein the navigation signaling is encoded with the estimated locations of the one or more downed drones; and processing the navigation signaling to autonomously navigate the UAV.

The method of any of the preceding embodiments, wherein processing the navigation signaling includes: determining an estimated position of the UAV based on the estimated locations of the one or more downed drones.

The method of any of the preceding embodiments further comprising: generating navigation instructions based on the estimated position of the UAV to autonomously navigate the UAV.

The method of any of the preceding embodiments, wherein receiving the navigation signaling includes: executing a distributed positioning algorithm that enables estimation of a position of the UAV based on the estimated locations of the one or more downed drones.

The method of any of the preceding embodiments, wherein executing the distributed positioning algorithm includes: processing the navigation signaling to: (a) obtain absolute locations of at least a pair of UAVs from the one or more downed UAVs, and (b) determine relative ranges between the UAV and any of the UAVs; and determining an estimated position of the UAV based on the absolute locations and the relative ranges.

The method of any of the preceding embodiments, wherein receiving the navigation signaling includes: determining, by the UAV, a range between the UAV and the one or more downed drones using wireless positioning; and determining an estimated position of the UAV based on the range and the estimated locations of the one or more drones.

In some embodiments, an apparatus is disclosed. The apparatus comprising: one or more computer-readable media; and program instructions stored on the one or more computer-readable storage media that, when executed by one or more processors of an aerial vehicle, direct the one or more processors to at least: continually monitor one or more sensors or sub-systems of the aerial vehicle to determine that the aerial vehicle has been downed; and responsive to detecting that the aerial vehicle has been downed, entering a downed state, wherein in the downed state, the aerial vehicle: determines an estimated location of the aerial vehicle, deactivates non-essential functions, sub-systems, and/or compute, and periodically broadcasts RF and/or visual signals (using IR and/or visible LEDs) that include the estimated location of the aerial vehicle.

The apparatus of any of the preceding embodiments, wherein continually monitoring includes: determining that the aerial vehicle is downed based on a determination that the aerial vehicle is experiencing lost or degraded global positioning system (GPS) and/or communication signaling.

The apparatus of any of the preceding embodiments, wherein entering the downed state includes: determining the estimated location using a GPS receiver onboard the aerial vehicle, and adjusting the estimated location based on (a) movement data received from an inertial measurement unit (IMU) and/or (b) environmental data received from a barometer onboard the aerial vehicle.

In some embodiments, a tangible, non-transitory, machine-readable medium storing instructions that, when executed by a data processing apparatus, cause the data processing apparatus to perform operations comprising those of any of the above embodiments is disclosed.

In some embodiments, a system is disclosed. The system comprising: one or more processors; and memory storing instructions that, when executed by the processors, cause the processors to effectuate operations comprising those of any of the above embodiments.

In some embodiments, a system comprising means for performing any of the above embodiments is disclosed.

What is claimed is:

1. A system configured to enhance resilience against electronic warfare, comprising:
a plurality of drones each configured to switch to a low power mode upon being downed;
a processing system configured to:
continually determine whether a drone of the plurality of drones has been downed, and
emit a beacon signal from a downed drone, the beacon signal containing position data; and
a communication system enabling formation of a mesh network among downed and active drones of the plurality of drones.

2. The system of claim 1, wherein the beacon signal includes a radio frequency (RF) signal.

3. The system of claim 1, wherein the beacon signal contains the position data along with a confidence in the position data.

4. The system of claim 1, wherein the position data is determined using global positioning system (GPS) receiver onboard the downed drone.

5. The system of claim 4, wherein the processing system is further configured to adjust the position data based on environmental data received from a barometer onboard the downed drone.

6. The system of claim 4, wherein the processing system is further configured to adjust the position data based on movement data received from an inertial measurement unit (IMU) onboard the downed drone.

7. The system of claim 1, wherein the active drones include a first active drone, wherein the first active drone uses the beacon signal to determine a range from the downed drone.

8. The system of claim 7, wherein the range is determined using at least one Wi-Fi or Ultra-wideband (UWB) round-trip time (RTT) protocol.

9. The system of claim 1, wherein the beacon signal includes a visual signal emitted in a coded pattern, wherein the visual signal includes at least one of infra-red (IR) light or light from light emitting diodes (LEDs).

10. The system of claim 9, wherein the active drones include a first active drone, wherein the first active drone uses any of the visual signal or the position data for navigation.

11. The system of claim 1, wherein the processing system is further configured to:
switch the drone to a low-power mode in response to determining that the drone has been downed, wherein in the low-power mode, the drone deactivates non-essential systems and functions.

12. The system of claim 1, wherein the active drones include a first active drone, wherein the first active drone receives the beacon signal from the downed drone via one or more of the plurality of drones using the mesh network.

13. A method for controlling an unmanned aerial vehicle (UAV) to enhance resilience against electron warfare, the method comprising:
continually monitoring, by the UAV, one or more sensors or sub-systems of the UAV to determine that the UAV has been downed; and
responsive to detecting that the UAV has been downed, entering a downed state, wherein in the downed state, the UAV:
determines an estimated location of the UAV,
deactivates non-essential systems and functions, and
periodically broadcasts any of radio frequency (RF) signal or visual signal that include the estimated location of the UAV.

14. The method of claim 13, wherein continually monitoring includes:
determining that the UAV is downed based on a determination that the UAV is experiencing lost or degraded global positioning system (GPS) and/or communication signaling.

15. The method of claim 13, wherein entering the downed state includes:
determining the estimated location using a GPS receiver onboard the UAV, and
adjusting the estimated location based on (a) movement data received from an inertial measurement unit (IMU) and/or (b) environmental data received from a barometer onboard the UAV.

16. The method of claim 13, wherein entering the downed state includes:
periodically broadcasting the RF signal as an ultra-wideband (UWB) signal.

17. The method of claim 13, wherein entering the downed state includes:
detecting a spoofed GPS signal; and
rejecting the spoofed GPS signal.

18. An autonomous unmanned aerial vehicle (UAV) comprising:
one or more sensors configured to capture perception inputs of a physical environment;
a propulsion system configured to maneuver the UAV through the physical environment;
a communication system configured to receive navigation beacon signals transmitted by a set of downed UAVs in a plurality of UAVs, wherein the navigation beacon signals is encoded with estimated locations of the set of downed UAVs; and
a processing system configured to:
determine that the UAV is experiencing any of lost or degraded global positioning system (GPS) or communication signaling,
process the navigation beacon signals transmitted by the set of downed UAVs to generate navigation instructions, and
process the navigation instructions to direct the propulsion system to navigate the UAV.

19. The autonomous UAV of claim 18, wherein the processing system is configured to:
execute a distributed positioning algorithm that enables estimation of a position of the UAV based on the estimated locations of the set of downed UAVs.

20. The autonomous UAV of claim 18, wherein the processing system is configured to:
process, via a distributed positioning algorithm, the navigation beacon signals to:
(a) obtain absolute locations of at least a pair of UAVs from the set of downed UAVs, and
(b) determine relative ranges between the UAV and any of the UAVs; and
determine an estimated position of the UAV based on the absolute locations and the relative ranges.
